(19) United States
(12) Patent Application Publication
(10) Pub. No.: US 2006/0101232 A1
(43) Pub. Date: May 11, 2006

(54) Semiconductor integrated circuit

(75) Inventors: Masashi Takada, Kokubunji (JP); Takanobu Tsunoda, Kokubunji (JP); Hiroshi Tanaka, Kokubunji (JP); Tetsuroo Honmura, Sagamihara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/240,549

(22) Filed: Oct. 3, 2005

(30) Foreign Application Priority Data
Oct. 5, 2004 (JP) 2004-292056

(51) Int. Cl. G06F 15/00

(52) U.S. Cl. 712/10

(57) ABSTRACT

The present invention relates to data access to a built-in memory or a peripheral circuit from any of ALU cells provided in the array state, and provides a semiconductor integrated circuit having an access mechanism enabling size reduction in the hardware scale and improvement in the usability.

There are provided dedicated cell groups 1304, 1306 for executing memory access processing to built-in memories 1313, 1312 in a plurality of ALU cells. Further there are provided dedicated cell groups 1304, 1306 enabling access commonly available for built-in memories to a peripheral circuit 1201 or LSI external device 206. By providing dedicated cell groups for memory access processing to built-in memories, the ALU cell does not require a memory access mechanism, which enables reduction of an area and improvement in efficiency in use. Further access common to the built-in memories or peripheral circuits is possible, which enables improvement in the usability.

### CLAIM OF PRIORITY

The present application claims priority from Japanese application JP 2004-292056, filed on Oct. 5, 2005, the content of which is hereby incorporated by reference into this application.

### BACKGROUND OF THE INVENTION

1. Field of the Invention

The present invention relates to a semiconductor integrated circuit and to an LSI and two-dimensional ALU cell array capable of implementing various types of processing by dynamically changing the processing function and configuration data for data transfer. In particular, the invention relates to a method of data access with a built-in memory, a peripheral circuit, and an LSI external device by the ALU cell array and to a circuit used therefor.

2. Description of the Related Arts

Performance of a semiconductor integrated circuit has been improved by increasing the number of transistors which can be integrated on a chip as indicated by the Moore's Law. However, increase in the number of transistors results in increase in circuit information implemented in a mask, so that the mask cost has been increasing year by year. Further also enlargement in a scale of a designed circuit results in increase in the number of required mask sheets, which causes a steep rise of ASIC development cost. Further in association with diversification of needs, mass production of a few types of products has shifted to small-lot production of various types of products, and also the product trend changes within a short period of time, which requires shortening of a period of time required for development of each product.

Recently a reconfigurable processor has been proposed as a technique for solving the problems as described above. As disclosed in Japanese Patent Laid-Open No. 2002-76883, a reconfigurable processor has a number of processing units each having the versatility enabling various types of operations and switching units capable of flexibly switching connection between the processing units and can implement various circuits by switching the configuration data which is control information for the units above. As described above, because the reconfigurable processor is a programmable processor like an FPGA, the initial development cost and a period required for development thereof can be reduced and shortened as compared to those for ASIC. Further the reconfigurable processor ensures the high processing performance by reducing a freedom degree in wiring and making coarser the fineness of operations. Further a dynamic reconfigurable processor has been proposed for executing the processor by dynamically switching the configuration. Because the dynamic reconfigurable processor can implement a number of operations on a chip, performance per area is improved and thereby the influence on unit price of a chip, which is problematic in the FPGA, can be reduced.

Generally a reconfigurable processor has a number of ALU cells in the processing unit, and realizes improvement of the processing performance by making the ALU cells operate in parallel spacially and concurrently. As a result, the performance is limited in data supply as compared to the conventional type of processors. To overcome the problems, a small-scale memory is incorporated therein to improve the performance for data transfer by accessing thereto from the ALU cell. The example will be described in “NIKKEI Electronics” No. 835, pp. 59-66, 2002. 11. 18.

### SUMMARY OF THE INVENTION

A reconfigurable processor generally has a processing unit with multi-functional ALU cells provided on a two-dimensional array. Because the parallelism of ALU cells is high in this structure, a method of interconnection between ALU cells and between an ALU cell and a built-in memory gives severe influence over the processing performance.

As a method of the interconnection as described above, in some cases, a plurality of ALU cells and built-in memories are connected with a bus, and in another example a bus is not provided and data transfer is performed between adjoining ALU cells or between an ALU cell and a built-in memory. In the configuration using a bus, the bus area is very large, generally the number of ALU cells or built-in memories connected to a bus is limited, or a part of connection is limited between adjoining ALU cells or between a ALU cell and a built-in memory.

There are the following common problems in all of the configurations described above. Generally the ALU cells have the common structure and are therefore scalable, but also an ALU cell not adjoining a bus nor a memory and not capable of executing memory access requires a larger area when the ALU cell has a memory access mechanism. An ALU cell adjoining a bus or a memory is frequently used for memory access, so that the processing function can not effectively be utilized.

To solve the problems as described above, it is an object of the present invention to provide a memory access mechanism enabling reduction of an area of the processing unit and effective use thereof.

Further the present invention enables improvement in usability by configuring the memory access mechanism commonly available by a peripheral circuit and an LSI external device connected to a dedicated IO interface.

Brief descriptions of outlines of the representative inventions disclosed in this patent application are provided below. That is a semiconductor integrated circuit according to the present invention has ALU cells arranged in the array state; a processing unit with a function for data transfer between the ALU cells; built-in memories arranged around and inside the processing unit; and a group of dedicated cells for executing memory access to any of the built-in memories, and in the semiconductor circuit, the operating unit and the group of dedicated cells have a storage area for dynamically specifying the configuration data respectively.

Preferably, a plurality of the dedicated cell groups exist in association with a plurality of ALU cells in the processing unit present in the closest position to the built-in memory, and execute an operand access to the built-in memory.

Preferably, a plurality of the built in memories exist in association with a plurality of the ALU cells in the processing unit, have a single contiguous address space in response to a memory access from the outside of the semiconductor integrated circuit, and have respective address spaces in response to a memory access from the processing unit.

Preferably, a plurality of the dedicated cell groups exist in association with a plurality of the built-in memories, and execute an operand access uniquely in association with each of the memory accesses.

Preferably, the dedicated cell groups include the built-in memory; a peripheral device with a dedicated IO interface connected to the semiconductor integrated circuit; and a data access mechanism commonly available to an LSI external device connected with a dedicated IO interface connected to the semiconductor integrated circuit; wherein the dedicated IO interface has a memory area for dynamically specifying a destination for connection thereof.

With the present invention, an area of a semiconductor integrated circuit can be reduced.

### BRIEF DESCRIPTION OF THE DRAWINGS

FIG. 1 is a view showing usage and positioning of an in-vehicle software defined radio according to one embodiment of the present invention;

FIG. 2 is a block diagram showing the software defined radio according to one embodiment of the present invention;

FIG. 3 is a view showing second structure of a preprocessing section of the software defined radio according to one embodiment of the present invention;

FIG. 4 is a block diagram showing a dynamic reconfiguration (DR) chip according to one embodiment of the present invention;

FIG. 5 is a block diagram showing a DRE according to one embodiment of the present invention;

FIG. 6 is a block diagram showing an ALUAE according to one embodiment of the present invention;

FIGS. 7A to 7C are views showing general configuration of a setting register in the ALUAE according to one embodiment of the present invention;

FIGS. 8A to 8C are block diagrams showing a control/status register in an AECTL according to one embodiment of the present invention;

FIG. 9 is a block diagram showing a control/status register in a CNFGC according to one embodiment of the present invention;

FIG. 10 is a view showing configuration data in the case where the filtering processing is executed by using an ALU cell according to one embodiment of the present invention;

FIG. 11 is a block diagram showing the ALU cell according to one embodiment of the present invention;

FIG. 12 is a block diagram showing a configuration register in the ALU cell according to one embodiment of the present invention;

FIG. 13 is a view showing an interface between an LS cell and an ALU cell according to one embodiment of the present invention;

FIG. 14 is a block diagram showing an IO block according to one embodiment of the present invention and an IOCTL as a component of the IO block;

FIG. 15 is a block diagram showing a configuration register of an LS cell according to one embodiment of the present invention;

FIG. 16 is a block diagram showing a configuration register of an IOCTL according to one embodiment of the present invention;

FIG. 17 is a view showing an ALUAE and an external data access mechanism according to one embodiment of the present invention and positioning of an EXIOS;

FIGS. 18 are block diagrams showing a configuration register in the EXIOS according to one embodiment of the present invention;

FIG. 19 is a view showing an example of setting of the configuration register for access from the LS cell according to one embodiment of the present invention to a local memory;

FIG. 20 is a view showing configuration of the LS cell according to one embodiment of the present invention;

FIG. 21 is a view showing an example of setting of a configuration register for access from the LS cell, IO port, EXIOS each according to the present invention to a WCE;

FIG. 22 is a view showing operations when the LS cell, IO port, and EXIOS each according to the present invention access the WCE;

FIG. 23 is a view showing an example of setting of the configuration register for access from the LS cell, IO port, EXIOS each according to one embodiment of the present invention to an ADC/DAC;

FIG. 24 is a view showing operations when the LS cell, IO port, EXIOS each according to one embodiment of the present invention access the ADC/DAC;

FIG. 25 is a view showing operations when the LS cell, IO port, EXIOS each according to one embodiment of the present invention access the ADC/DAC for reading out data written therein from the ADC/DAC; and

FIG. 26 is a view showing configuration of a memory controller according to one embodiment of the present invention.

### DETAILED DESCRIPTION OF THE PREFERRED EMBODIMENTS

A representative embodiment of the present invention will be described in detail below with reference to related drawings. In this embodiment, the present invention is applied to a software defined radio constituting a telematics terminal. In a software defined radio, the communication system must be switched according to an object of communication or to the environment for operations, and therefore the software defined radio is suitable for an application of a reconfigurable LSI (dynamic reconfigurable circuit). In the following descriptions, the same reference numerals and same signs indicate the same or similar components respectively.

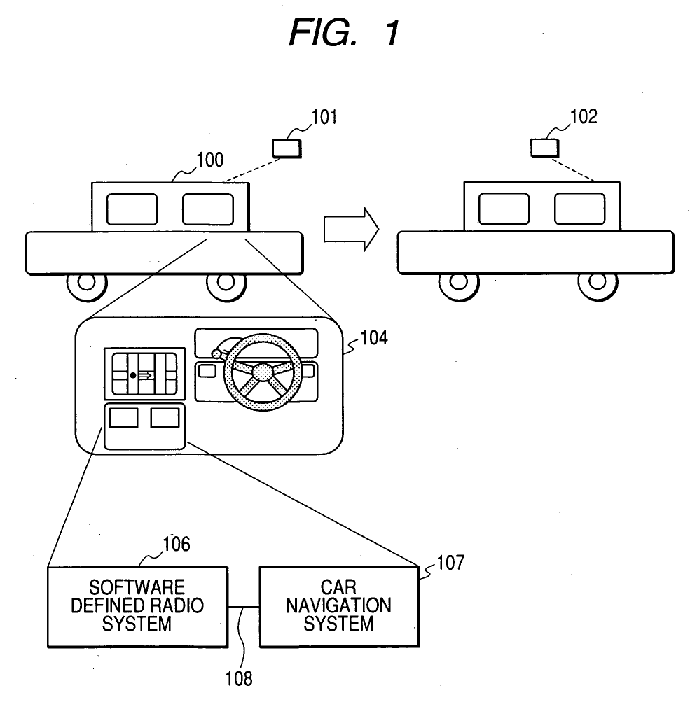

FIG. 1 is a view showing an example of a telematics terminal 104 mounted in a vehicle 100, and this example indicates a system application of a software defined radio 106 constituting a telematics terminal. The software defined radio as used herein indicates a radio in which the specifications not changeable in the conventional technology are changed by software.

In the software defined radio, when the radio specifications are changed in the future, or when required optimal radio specifications change during running in relation to positional relations with radio stations 101 or 102 or according to the situation of electric wave, the radio specifications can flexibly be changed in response to changes in the radio specifications. The radio specifications to be changed include, for instance, those for a radio LAN, an ETC (DSRC), a terrestrial DTV communication, and the like.

Descriptions are provided below for structure of the software defined radio, and positioning, structure, and usage of a DR chip using a dynamic reconfigurable circuit.

1. Structure of a software defined radio and positioning of a DR chip

In FIG. 1, the telematics terminal 104 administrates processing for video or audio information in a car navigation system 107, and uses a software defined radio system 106 for transmitting data to the car navigation system 107. A standard data communication interface such as a USB is used as an interface 108 between the car navigation system 107 and the software defined radio 106.

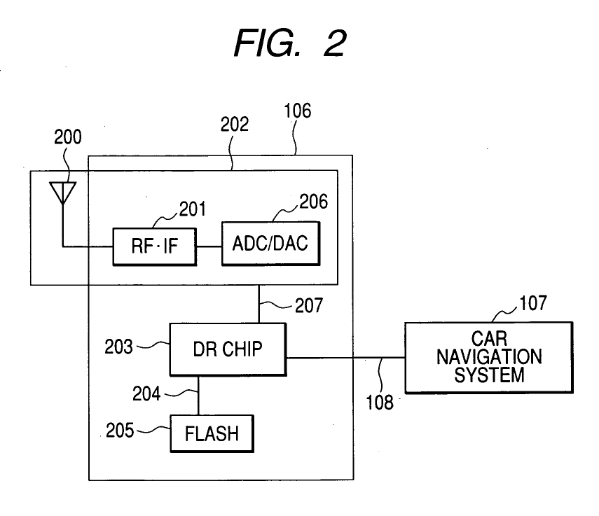

FIG. 2 is a block diagram showing internal structure of the software defined radio 106. Radio data passes through an analog processing unit 202 and is converted to digital data, and the digital data is processed in a dynamic reconfigurable chip (DR chip) 203, and the processed digital data is transferred via the interface 108 to the car navigation system 107. When data is transmitted, the data is transferred through the same path, but in the reverse direction. The DR chip can change the circuit configuration in response to an operation to be executed by changing the configuration data during the actual operations. In this embodiment, the DR chip can be used for both data receiving and data transmission by switching the circuit configuration between that in a first period for receiving data and that in a second period for data transmission, so that the DR chip can be realized with a small area.

The analog processing unit 202 comprises an antenna 200, an RF/IF circuit 201, an analog-digital converter (ADC), and a digital-analog converter (DAC). The ADC is used for receiving data, while the DAC is used for data transmission. A FLASH 205 in the digital processing unit is used for storing therein various types of programs.

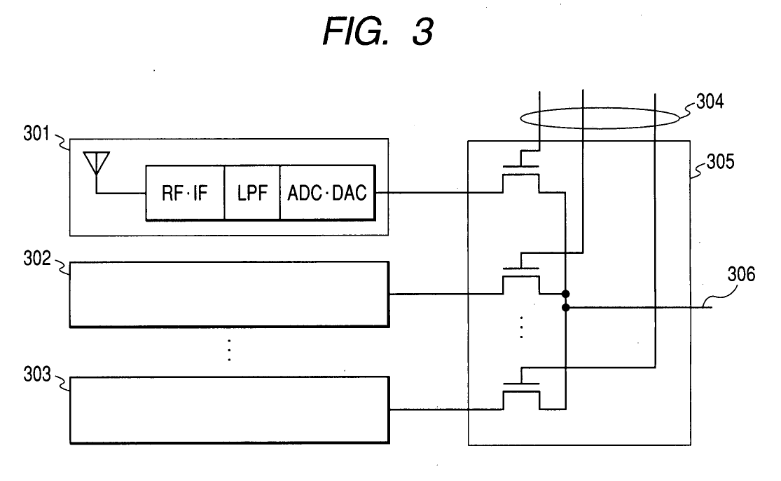

FIG. 3 shows structure in which a plurality of analog processing units are used for several frequency bands as another embodiment of the analog processing unit 202 shown in FIG. 2. In FIG. 3, the reference numerals 301, 302, 303 indicate analog processing units prepared for difference frequency bands respectively. A radio signal switch unit 305 starts operating in response to a control signal 304 deciding radio specifications to be used and selects which analog processing unit to be connected to the digital processing unit. The control signal 304 is part of the signals transacted at a path 207 of FIG. 2. The digitalized data is sent through a path 306, which is also part of the path 207, to the digital processing unit.

2. Structure of DR Chip

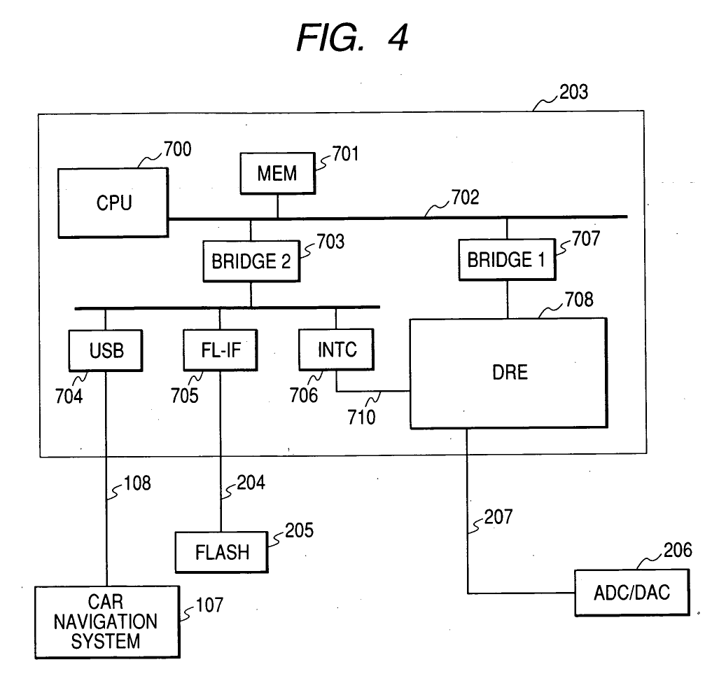

Descriptions are provided below for configuration of the DR chip 203 for executing the digital signal processing and an interface between the software and hardware with reference to FIG. 4. The software is executed by a CPU 700 on the DR chip 203.

2.1 General structure of DR Chip

As shown in FIG. 4, a DR chip includes an ADC/DAC 206, a car navigation system 107, an interface circuit with a FLASH 205 which is a ROM, a DRE 708 for demodulating and modulating received or transmitted signals, and a central processing unit CPU 700 for providing general controls over the system and executing preprocessing for demodulation and modulation of received and transmitted data.

At first, a peripheral interface of the DR chip 203 will be described. The ADC/DAC 206 is connected to the DRE 708 via an input/output signal line 207. The car navigation system 107 is connected to an USB interface 704 via an input/output signal line 108. The FLASH 205 for storing therein programs and the like is connected to a flash interface FL-IF 705 via an input/output signal line 204. The FLASH 205 stores therein software executed by the CPU 700, configuration data executed by the dynamic reconfigurable engine DRE 708 and the like. The configuration data as used herein indicates data for specifying hardware configuration (circuit configuration) of the DRE.

Next an interface between the DRE 708 and CPU 700 will be described. The CPU 700 is connected via a CPU bus 702 to the DRE 708 and built-in memory 701 as well as to the peripheral interface control circuit USB 704, FL-IF 705, or to an interrupt control circuit INTC 706. Data is transferred between the CPU bus 702 and these circuits via a bridge circuit 703 and a bridge circuit 707.

2.2 Structure of DRE

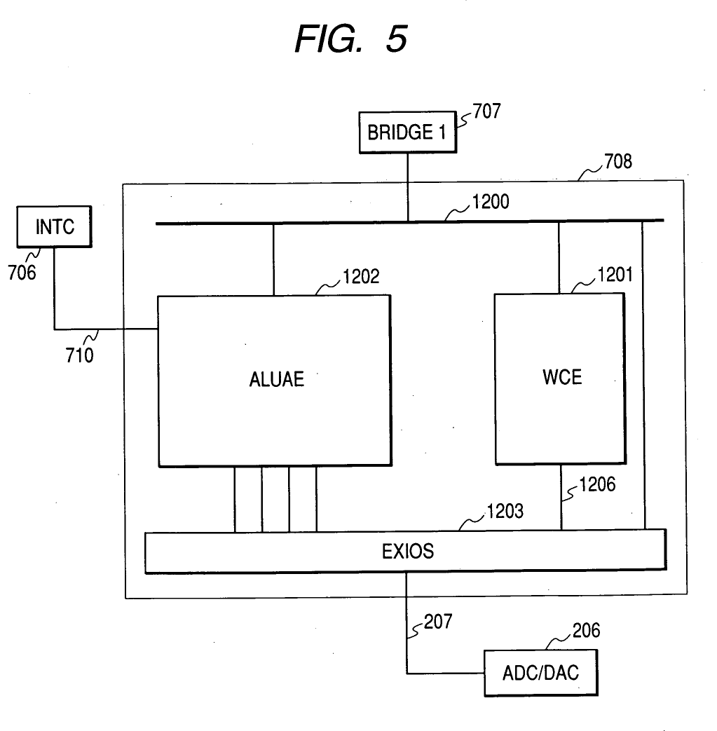

Structure of the DRE 708 shown in FIG. 4 will be described with reference to FIG. 5. The DRE 708 includes an ALUAE (ALU Array Engine) 1202, a radio-dedicated circuit WCE 1201, an internal bus 1200, and an external input/output switch EXIOS 1203.

The ALUAE 1202 is a circuit module realized with autonomous dynamic reconfiguration. The autonomous dynamic reconfiguration indicates that configuration of a circuit module is changed based on a result of computing by the circuit module itself. The EXIOS 1203 is a circuit for selecting an external data access target for the ALUAE 1202, and the access target is the WCE 1201 or the ADC/DAC 206 outside the LSI. Interrupt is made by notifying the INTC 706 of a demand via a bus 710. Ordinary data transfer between the ALUAE 1202 and WCE 1201 can be executed via the internal bus 1200. Data transfer between the CPU 700 and ALUAE 1202 or between the CPU 700 and WCE 1201 is executed between the bridge 707 and the internal bus 1200. The WCE 1201 is a circuit module for realizing radio-specific operations. The radio-specific operations include, for instance, a CRC/Scramble operation. When these operations are executed by an ALUAE which processes a plurality of bits in parallel for executing 1-bit unit processing, the efficiency is rather low. The efficient will be improved if a module as a dedicated circuit is provided.

3. Structure of ALUAE and Setting Register

3.1 Outline

Outline of structure of the ALUAE 1202 and setting register will be described below.

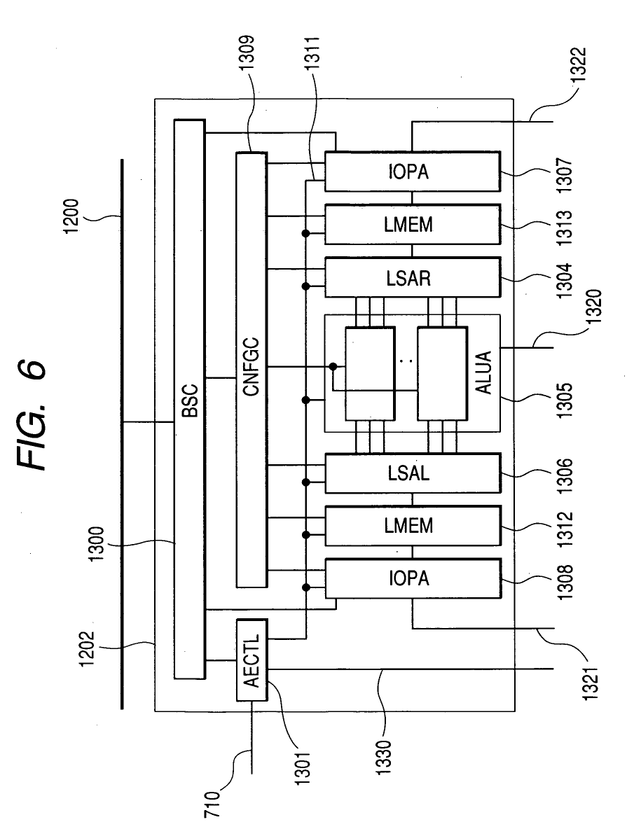

FIG. 6 shows structure of the ALUAE 1202. The ALUAE 1202 is connected via a BSC 1300 to the internal bus 1200. A main function of the BSC 1300 is to distribute input from the internal buss 1200 to each unit. An AECTL 1301 controls operations of the ALUAE 1202, and further issues an interrupt request to the interrupt controller INTC 706.

A main block for administrating various types of processing is an ALUA 1305. The ALUA 1305 includes ALU cells provided in the array state. A load/store array LSA which is a group of dedicated cells is used for data transfer between the ALUA 1305 and a memory or an internal device. The LSA has a plurality of load/store cells (LS cells) as described hereinafter. The LSA is divided to an LSAR 1304 positioned in the right side and LSAL 1306 (LS cell) positioned in the left side. That is, there is an area in which ALU cells are provided in matrix between the LSAR and LSAL. Input/output to and from the ALUA 1305 is performed via the LSAR or LASL. When the LSAR and LSAL are positioned between the ALUA and other external devices, the distance to the external devices is shortened, so that also the time required for data transfer can be shortened.

LMEMs 1312 and 1313 are provided at positions adjoining the LSAL 1306 and LSAR 1304 respectively, and each have a local memory and an interface for the local memory therein. Input/output to the LMEMs are executed by the LSA or an IOP.

Each of IOPAs 1308 and 1307 is provided in adjacent to the LMEM, and communicates with the internal bus via the BSC 1300. Further each of the IOPAs 1308 and 1307 communicats with the. WCE and the ADC/DAC outside the DR chip via paths 1321, 1322, and EXIOS.

The ALUA 1305, LSA (LSAR 1304 and LSAL 1306), LMEMs (1312, 1313), IOP (IOPA 1307, 1308) can dynamically change the configuration during processing for changing the functions and access targets.

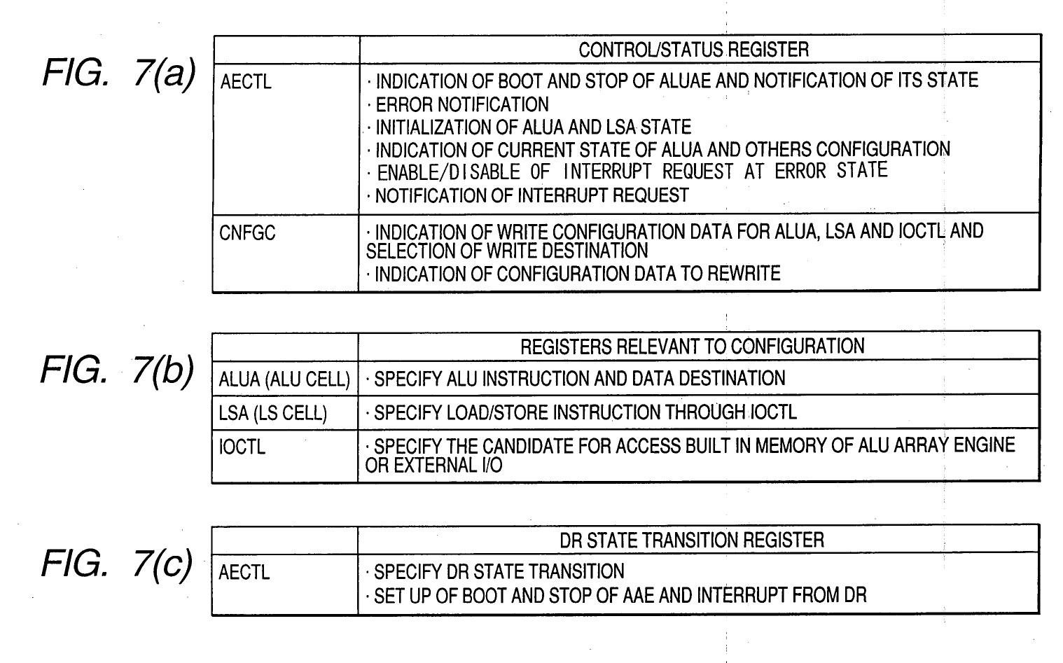

The configuration register provide instructions for operations of the modules, and there are the types of modules each having the functions as shown in FIG. 7B. A buffer used for temporally storing data therein for changing configuration of the configuration register is present in a CNFGC.

Any of the ALUA 1305, LSA (LSAR 1304 and LSAL 1306), LMEMs (1312, 1313), and IOP (IOPA 1307, 1308) is divided to a plurality of clusters each having 8 rows, so that the configuration can be changed cluster by cluster.

In the embodiment of the present invention described below, it is assumed that there are two clusters. Details of the configuration register above will be described in details hereinafter. An ordinary buffer may be used as a buffer for the CNFGC 1309.

The AECTL 1301 provides controls for the ALUAE 1202 as a whole as well as for switching of the configuration as shown in FIG. 7A and FIG. 7C. The AECTL 1301 also provides, in addition to general controls over the hardware such as starting and terminating and notification of the current status, controls for autonomously switching configuration of the ALUA 1305, LSA (LSAR 1304 and LSAL 1306), LMEMs (1312, 1313), and IOP (IOPA 1307, 1308) in the ALUAE itself as well as controls notifying the current state of configuration and interrupt for switching thereof and enabling or disabling notification of an error. An input 1330 to the AECTL 1301 is used for switching the configuration. Operations of the registers will be described in detail hereinafter.

The CNFGC 1309 provides controls for an operation of writing configuration data to an object having the configuration register described above. Content of the controls is as shown in FIG. 7A. The registers will be described in detail hereinafter.

3.2 AECTL and CNFGC Control/Status Register

Descriptions are provided for the AECTL 1301 and a control/status register in the CNFGC 1039 in this section.

(1) Control/status Register in the AECTL

The AECTL 1301 includes therein a control register 1500 and an interrupt control register 1510 shown in FIG. 8. The control register 1500 provides general controls and performs status notification, while the interrupt control register 1510 executes setting for an interrupt.

EN and ST in the control register 1500 provide an instruction (EN) for starting or terminating an operation of the ALUAE 1202 in the sense of hardware and a notification (ST) of status as a result of the operation. When the EN is set to 1, starting of an operation is instructed, and when the EN is set to 0, termination of an operation is instructed. When the ST is set to 1, it indicates that the operation is being executed, and when the ST is set to 0, it indicates that the operation is now down. ERR indicates an error. 1 indicates an error, and 0 indicates the normal state. INI 1 and INI 0 specify initialization of the internal state of the ALUAE. INI 1 specifies initialization of a cluster 1 (for upper 8 rows), while the INI 0 indicates initialization of a cluster 0 (for lower 8 rows). When initializing, all of the internal memory elements are set to 0 or 1. C1ST and C0St indicate a configuration number currently being used in the ALUAE respectively. C1ST indicates a configuration number of the cluster 1, while C0ST indicates a configuration number of the cluster 0. In this embodiment, 4 bits are allocated to the C0ST and C1ST respectively, and 16 types of configurations can be switched under control.

Next descriptions are provided for the interrupt control register 1510. The ERR in the interrupt control register 1510 specifies whether an interrupt request is to be issued or not when an error occurs in the ALUAE 1202. 1 indicates that an interrupt is executed, while 0 indicates that an interrupt is not executed. SIRQF in the interrupt control register 1510 specifies whether an interrupt is to be executed during state transition or not. SIRQ has a number of bits equal to a number of state transition control registers 1520, and setting may be set for each state transition whether an interrupt is to be made or not. SIF in the interrupt control register 1510 indicates a factor of an interrupt. Each bit in the SIF corresponds to an interrupt expressed by each bit in the SIRQ in the state of 1 versus 1. Zero reset of the SIF indicating a factor for an interrupt is executed by data write from outside of the DRE or by resetting the DRE.

(2) Control/Status Register in CNFGC

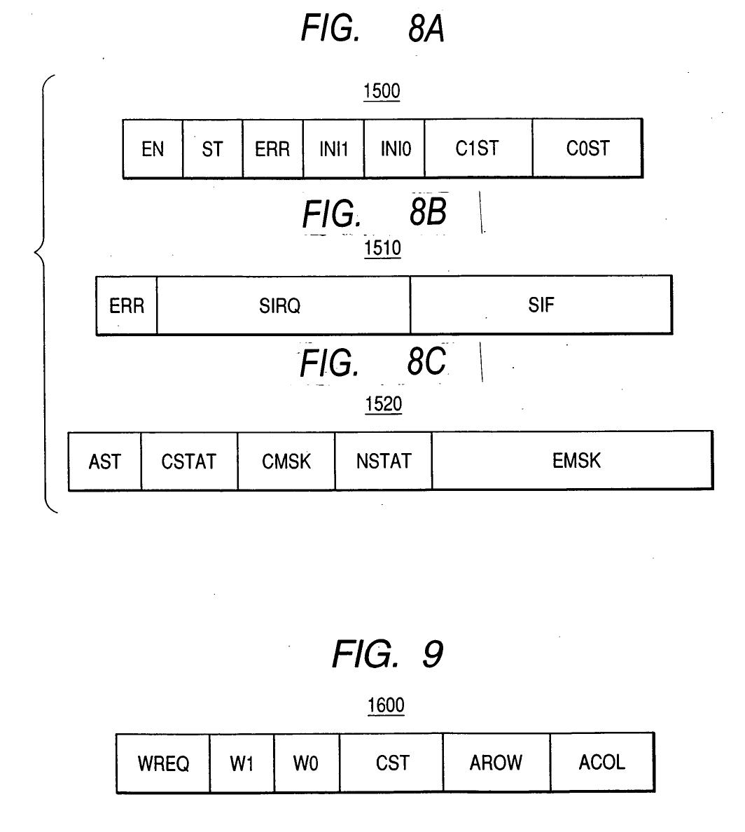

A register in the CNFGC is shown at 1600 in FIG. 9.

WREQ in the register 1600 is set to 1 when data write to a cell as a target for configuration is instructed. W0 and W1 indicates cluster each as a target for data write. When W1 is set to 1, data is written in the cluster 1, and when W0 is set to 1, data is written in the cluster 0. CST indicates a configuration number of the target for data write. AROW and ACOL indicate selection numbers each for an ALU cell with which the configuration is changed, and select a row and a column in each cluster.

(3) Control/DR State Transition Register in AECTL

The state transition register 1520 is shown in FIG. 8. The AECTL has a plurality of the state transition registers 1520 therein.

AST indicates the condition for switching that ALUAE 1202 is down or operating. 0 indicates that the ALUAE 1202 is down, and 1 indicates that the ALUAE 1202 is operating. This function is used for transition from the initial down state to the operating state.

When state transition is performed based on the configuration number currently in execution, the configuration number is specified in a CSTAT. CMSK indicates whether the current configuration number is to be regarded as a condition for state transition or not. 1 indicates that the current configuration is to be regarded as a condition for state transition, and 0 indicates that the current configuration is not to be regarded as a condition for state transition. A configuration number to which the current configuration number is transited is specified in NSTAT. An EMSK masks a trigger signal 1320 because a plurality of state transitions are treated by one state transition register 1520 for reducing a memory capacity in a status transition table. A logical OR is computed between the trigger signal 1320 and a value of EMSK, and when the result is all 1, state transition is executed. For instance, when the trigger set in the EMSK is generated by setting the CMSK to 1, the state transition is executed irrespective of the current configuration number.

3.3 Structure of ALU Cell and Configuration Register

Descriptions are provided in this section for structure of an ALU cell constituting the ALUA 1305 and also for the configuration register for clarifying usage of the ALU cell. In this section, how the processing in the ALUA 1305 is to be realized will be described in (1), and structure of an ALU cell will be described in (2). At last a configuration register in the ALU cell will be described in (3).

(1) Image concerning usage of the ALUA 1305

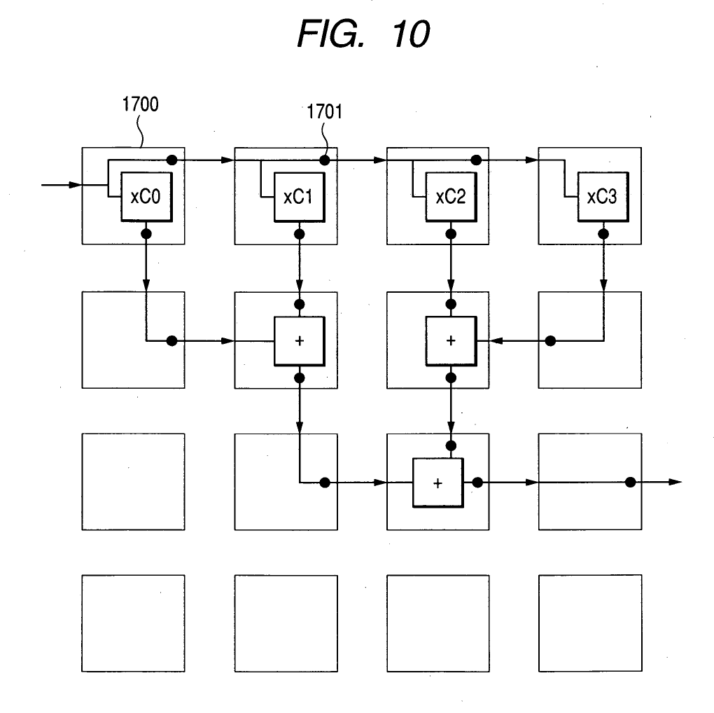

FIG. 10 is a view showing data for structure in which ALU cells 1700 are arrayed in a form of 4 rows and 4 columns and the filtering processing often employed for signal processing or the like is performed to the ALU cell array. Operation of the 4 rows×4 columns cell array will be described with reference to FIG. 10. The signs in blocks provided in the ALU cells 1700 (xC0, XC1, XC2, XC3, +) indicate functions executed by operators ALU in the respective cells, while a straight light and an arrow indicate data flows. Further black circles 1701 on the straight lines in the blocks indicates a flip-flop executing only data transfer with 1 cycle.

The configuration data shown in FIG. 10 is for computing the value-expressed by the expression below:
f[t]=e[t]×C0+e[t−1]×C1+e[t−2]×C2+e[t−3]×C3

In the expression f[t] indicates an output from a filter at the time point t, e[t] indicates an input to the filter at the time point t, and C0 to C3 indicate filter constants respectively. e[t] is inputted from the LSAL 1306 and f[t] is outputted to the LSAR 1304.

With the configuration data described above, a cell in the first row executes data transfer to an adjoining cell in the right side and multiplication, and also executes addition using cells in the second and third rows. By inputting an input e each time from a cell in the first row and first column to the ALUA 1305 set according to the configuration data, a filter output f can be acquired with a cell in the third row and fourth column in each cycle of 9-clock cycle and on. This embodiment is an example of circuit configuration of ALUA, and the circuit configuration can be changed by changing the configuration data.

(2) Structure of ALU Cell

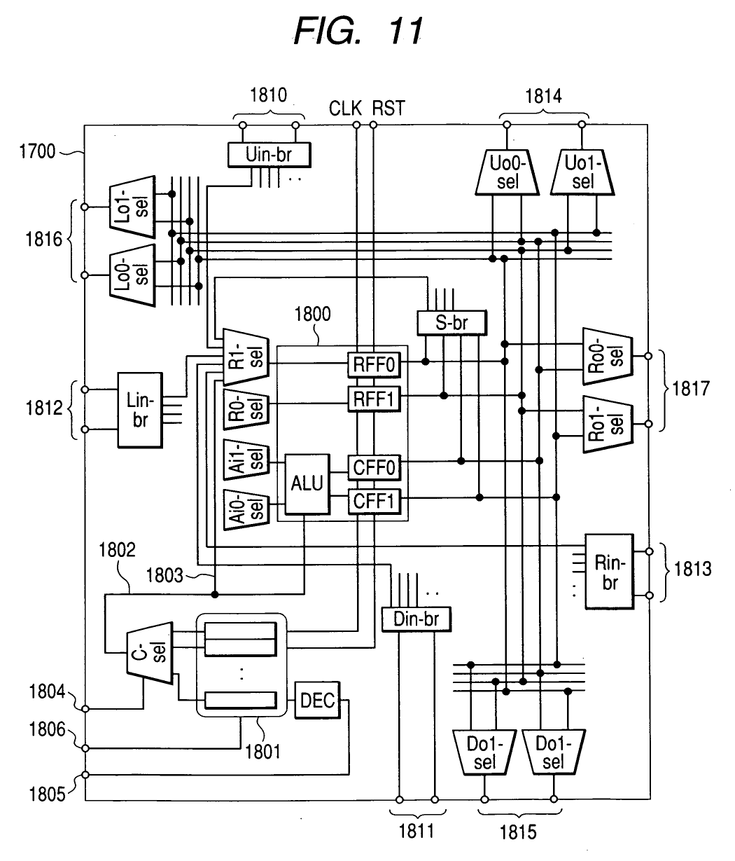

Structure of the ALU cell 1700 will be described below with reference to FIG. 11.

Functions of a datapath in the ALU cell is an operation by the ALU 1800 and a function for data transfer. The ALU receives outputs from a selector Ai0-sel and a selector Ai1-sel, and outputs a result to a flip-flop CFF0 and a flip-flop CFF1. When data transfer is executed, outputs from a selector R0-Sel and a selector R1-sel are inputted for the flip-flop RFF0 and flip-flop RFF1.

Inputs to the selectors Ai0-sel and Ai1-sel and those to selectors R0-sel and R1-sel are selected from outputs from input ports 1810, 1811, 1812, and 1813 and the flip-flops CFF0, CFF1, RFF0, and RFF1. A result of selection of the signals is decided according to a value of a signal 1802 selected in a selector C-sel in a configuration register file 1801.

Outputs from the ALU cell are provided from output ports 1814, 1815, 1816, and 1817 by selecting outputs from the flip-flops RFF0, RFF1, CFF0, and CFF1 with each switch.

Input ports and output ports are provided in top, down, left, and right positions and are directly connected to adjoining ALU cells in the respective sides. In this structure, the input port 1810 are connected to the output port 1814 in the top sides, input port 1811 to output port 1815 in the bottom side, input port 1812 to the output port 1816 in the left side, and input port 1813 to the output port 1817 in the right side. However, the wirings for the ALU cells at the right and left edges of the ALUA are connected to the ALU cell in the inner side and to the LS cell in the outer side. Further the wirings for the cells at the top and bottom edges are connected to the ALU cell in the inner side and are generally not connected to anything in the outer side. Up and down outward wirings of each of the ALU cells at four corners are connected to input/output lines 1320 from the ALUA 1305.

16 bits for data and 1 bit for control are allocated to each of the terminals and wirings, and the control bit is used for carry in addition, or for enable bit of load/store in an interface with the LS cell. Further a signal indicating whether the signal is valid or invalid (valid signal) is appended to each of the data signals and control signals. The valid signal is set to 1 when a data signal or a control signal is valid, and to 0 when a data signal or a control signal is invalid. The signal becomes valid for data inputted from outside of the ALUA or for data indicating a result of operation to valid data.

An input to the ALU cell is provided to input ports of terminals Uin-br, Din-br, Lin-br, and Rin-br in top, bottom, right and left sides, and the inputs are connected to all of the selectors R0-Sel, R1-sel, Ai0-sel, and Ai1-sel.

An output from the ALU cell are decided by selecting values of data transfer-registers RFF0, RFF1 and those of the ALU output registers CFF0, CFF1 with each of the switches for selectors Uo0-sel and Uo1-sel, for selectors Do0-sel and Do1-sel, for selectors Lo0-sel and Lo1-sel, and for selectors Ro0-sel and Ro1-sel. For instance, the selector Ro0-sel in the right side selects and outputs either RFF0 or CFF0, while the selector R01-sel selects and outputs either RFF1 or CFF1.

The selectors R0-sel, R1-sel, Ai0-sel, and Ai1-sel select one from two sets of terminals in each of the four sides, an output from the output selector S-br of the flip-flop, and a constant value 1803 in one configuration register selected from the configuration register file 1801 by the selector C-sel.

The ALU cell with the sign of “xC0” in FIG. 10 multiplies a value C0 obtained by selecting the constant value 1803 with the Ai0-sel and a value obtained by selecting an input signal from the left terminal Lin-br with the selector Ai1-sel with the ALU. A multiplication -result is outputted to CFF0 and CFF1, and CFF0 is selected with the selector Do0-sel, and CFF1 are selected with the selector Do1-sel, and the selected values are outputted to the output port 1815 in the bottom side. Further data transfer to the right side is made from the input port 1812 to the selector R0-sel and RFF0 and the data is outputted by the selector Ro0-sel to the output port 1817.

The selection of any among the various selectors and a selection as to what operation should be done by the ALU are decided according to a value of the output signal from the selector C-sel.

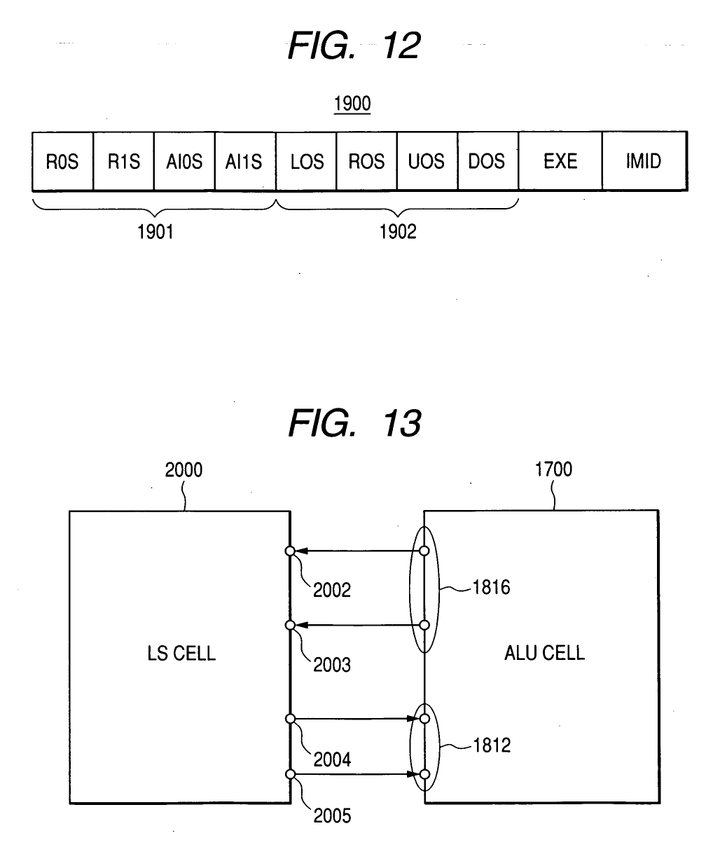

The signal 1802 indicates a value of a configuration register 1900 (FIG. 12) in the current state. This signal 1802 indicates a value selected by the selector C-sel according to a signal 1804 selecting the current configuration in the configuration register file 1801.

Now descriptions are provided for controls with which the configuration register file 1801 is updated. The configuration register file 1801 is updated by the CNFGC 1309 shown in FIG. 9. By specifying an ALU cell with the control register 1600 in the CNFGC 1309, the input port 1805 receives a signal indicating an address of the configuration register file 1801 for this ALU cell. A value inputted to the input port 1805 is decoded by the DEC to a white enable signal to a specified register. The input port 1806 is used for data write to the register in the state. The configuration register file 1801 is updated according to the two values inputted to the input ports 1805 and 1806. The signals inputted to the input ports 1805 and 1806 are part of output signals from the CNFGC 1309 shown in FIG. 6.

A signal inputted to the input port 1804 for deciding an operation of the C-sel is part of output signals 1311 from the AECTL 1301 shown in FIG. 6.

The mechanism for the configuration register file 1801 and C-sel is the same as that for other configuration object blocks, LS cell and IOCTL.

(3) Configuration Register

Descriptions are provided below for the configuration register 1900 of the ALU cell for realizing the operations described in section (2).

In the configuration register 1900, an area 1901 is for a select signal for the selectors R0-sel, R1-sel, Ai0-sel, and Ai1-sel, and the signal is generated by selecting a pair of 17 bits from totally 10 pairs of inputs including airs of input ports for the terminals Lin-br, Rin-br, Uin-br, Din-br, as well as S-br and IMID in the configuration register 1900. R0S, R1S, A10S, A11S indicate select code for the selectors R0-sel, R1-sel, Ai0-sel, and Ai1-sel.

An area 1902 is for a control signal to the output selectors Lo0-sel, Lo1-sel in the left side, output selectors Ro0-sel, Ro1-sel in the right side, output selectors Uo0-sel, Uo1-sel in the top side, and output selectors Do0-sel, Do1-sel in the bottom side. For instance, LOS indicates a control signal to the selectors Lo0-sel, Lo1-sel. Similarly, ROS, UOS, and DOS indicate control signals for two selectors in respective sides.

EXE indicates an operation executed by an ALU cell. Namely the EXE indicates arithmetic operations such as multiply, add, and subtract, or logical operations such as shift and AND. The IMID indicates a constant, and is a pair of inputs to ALU such as RO-sel and to an input selector to a transfer register.

3.4 Data Load/Store Unit

Descriptions are provided in this section for the data load/store unit as viewed from the side of the ALU array 1305.

Load/store is largely divided to two types. One is access to a local memory appended to each of the LMEMs 1312 and 1313, and another is access to a hardware module outside the ALUAE 1202 and to an IO outside the DR chip. Either access is performed through a load/store dedicated cell referred to as an LS cell.

Descriptions are provided below for LSA (1306, 1304), LMEMs (1312, 1313), and IOPAs (1308, 1307). At first an interface between the LS cell and ALU cell will be described in section (1). Then general configurations of LSA, LMEM, and IOPA will be described in section (2), an access mechanism to an LMEM 2200 will be described in section (3), and an access mechanism to the outside through an IOPA 2100 will be described in section (4).

(1) Interface between LS cell and ALU cell

FIG. 13 shows an interface between a load/store LS cell 2000 in the LSA and an ALU cell 1700.

An upper half of the output data terminal 1816 in the ALU cell 1700 is used for an address and R/W bits, while a lower half thereof is used for data outputted to outside of the ALU cell. The terminal 1812 receives data inputted from the LS cell. The LS cell 2000 connects ports of the ALU cell 1700 to ports 2002, 2003, 2004, and 2005. It is preferable that the LS cells be the same in number as the ALU cells arranged in the array state in one row along the LSAR (for instance, 16 LS cells when 16×16 ALU cells are arranged). The configuration described above is preferable because the ALU cells each outputting a result of an operation or receiving operation data and load/store cells each generating an address at which a result of an operation is to be stored or at which data to be inputted to an ALU cell is stored correspond to each other in the state of 1 versus 1 and data can be inputted to or outputted from the ALU cells concurrently.

(2) General structure of LSA, LMEM, and IOPA

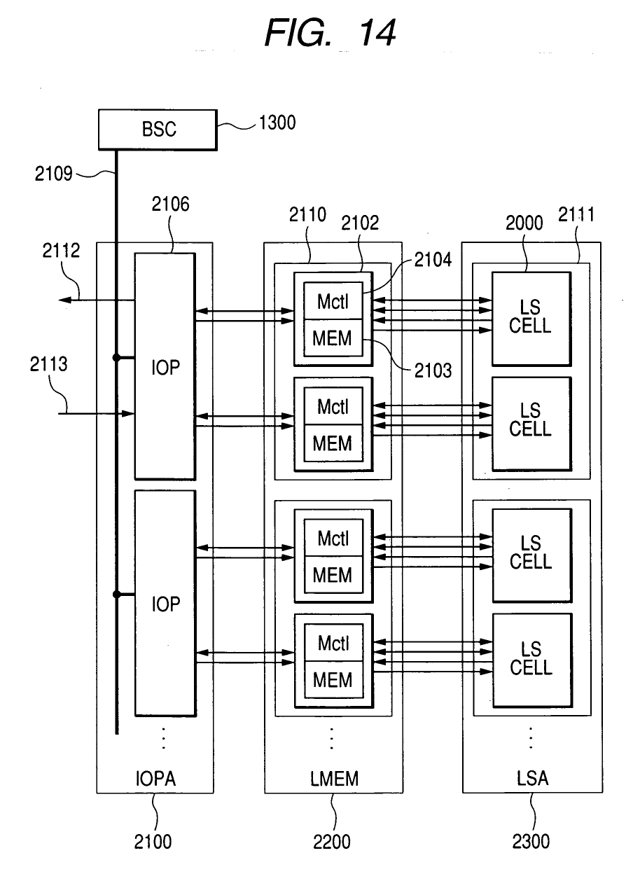

FIG. 14 is a view showing general structure of the LSAs (1306, 1304), LMEMs (1312, 1313), and IOPAs (1308, 1307). The LSAs, LMEMs, and IOPAs are provided symmetrically in an ALUA respectively. Therefore, the LSAs, LMEMs, and IOPAs are generically expressed as LSA 2300, LMEM 2200, and IOPA 2100 in the following descriptions.

The LMEM 2200 can be accessed from both of the LSA 2300 and IOPA 2100. The LMEM 2200 is used by the LS cell 200 as an ordinary memory, and also functions as an intermediate buffer for access to an external device by the LS cell 2000.

The IOPA 2100 is a module for communications with an external IO directly connected to the ALUAE 1202 or with any other module. In this embodiment, the ADC/DAC 206 is an external IO device, and the WCE 1202 is the other module. Further the IOPA 2100 has also an interface with the BSC 1300 in the internal bus 1200, and selects either access to an external IO device or access to the internal bus 1200 through each IOP 2106.

(3) Access Mechanism to LMEM

Descriptions are provided for access from the LS cell 2000 to the LMEM 2200.

The LMEM 2200 includes a plurality of memory cells 2102 associated with the LS cells 2000. The memory cell 2102 includes a memory MEM 2103 which can be accessed from the LS cell 2000 or from the IOP 2106, and an Mctl 2104 for controlling access to the MEM 2103. With this structure, access from the LS cell to the memory cell can be performed row by row concurrently.

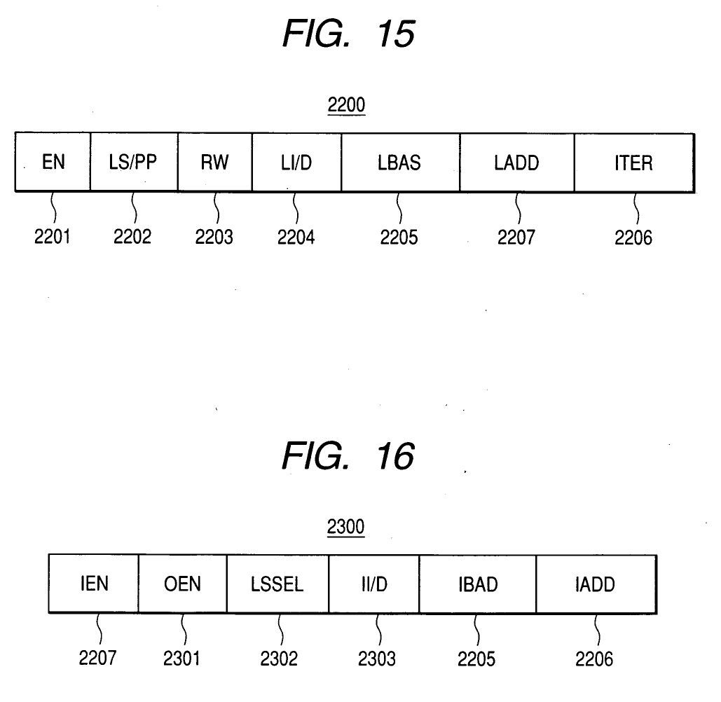

The Mctl 2104 has a function to select access from the LS cell because the memory cell 2102 can also be accessed from the IOP 2106. The configuration register 2200 for an LS cell shown in FIG. 15 specifies a command or a mode for access from the LS cell to the LMEM 2200. The functions will be described below.

An EN 2201 indicates whether data access from the LS cell is possible or not. An LS/PP 2202 specifies whether an address is given from the ALU cell 1700 or an address is to be automatically generated in the LS cell. An RW 2203 specifies data read or data write.

Descriptions are provided below for a method of setting a register when an address is automatically generated in the LS cell. An LI/D 2204 specifies whether an address is automatically incremented or decremented. An LBAS 2205 specified a base address. An LADD 2207 specifies a width for increment or decrement. An ITER 2206 specifies how many times access is to be repeated. After access is repeated maximum repetition times, the processing returns to the base address.

(4) Access Mechanism to Outside of the ALU Array

Descriptions are provided for an access mechanism to outside of the ALUAE through the IOPA 2100. At first, access from the IOPA 2100 to the LMEM 2200 will be described, and then access from the IOPA 2100 to the outside will be described.

(a) Access to LMEM from the Outside

The IOPA 2100 accesses a set 2110 of two memory cells 2102 through the IOP 2106. The IOP 2106 has a set of an input port 2113 and an output port 2112, and is connected to the BSC 1300 via wiring 2109.

The IOP 2106 is connected to the LS cell via the two memory cells 2102 each as an intermediate buffer. The input port 2113 and output port 2112 are connected to either one of the two memory cells 2102. Further the IOP 2106 may be selectively connected not only to the input/output ports, but also to the CPU bus 2109.

The IO port configuration register 2300 shown in FIG. 16 specifies various modes for the IOP 2106 described above. The functions will be described below. An IEN 2301 indicates whether access to the input port 2113 is possible or not. Similarly, an OEN 2302 indicates whether access to the output port 2112 is possible or not. When access to both of the input port 2113 and output port 2112 is impossible, the IOP 2106 selects access to the CPU bus 2109.

An LSSEL 2303 selects which of the two memory cells 2104 in the set 2110 to be accessed by the input port 2113 and output port 2112. Also which of the LS cells 2000 in the set 2111 to be accessed is decided according to this specification because the LS cell 2000 and the memory cell 2102 are connected to each other in the state of 1 versus 1.

For accessing from the outside, the IOP 2106 accesses a set 2110 of memory cells when an address is automatically generated. In this process, an II/D 2304, an IBAD 2305, and IADD 2306 are specified in correspondence to an LI/D 2204, an LBAS 2205, and an LADD 2207 in the LS cell configuration. The meaning is the same as that for the LS cell, and description thereof is omitted herefrom. A difference from the case of the LS cell is that access is repeated up to the maximum address of the memory.

(b) External Access

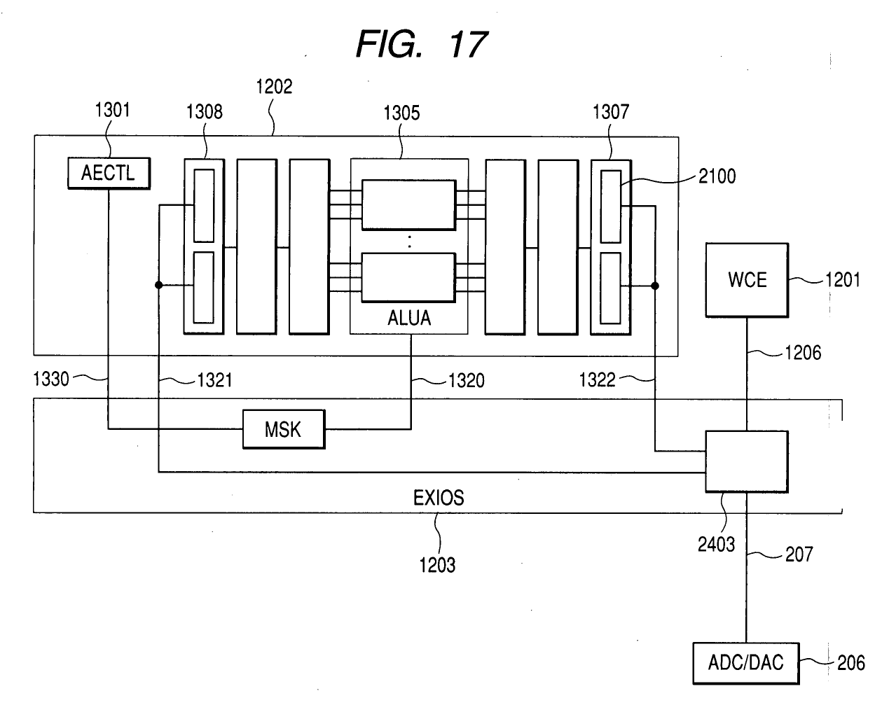

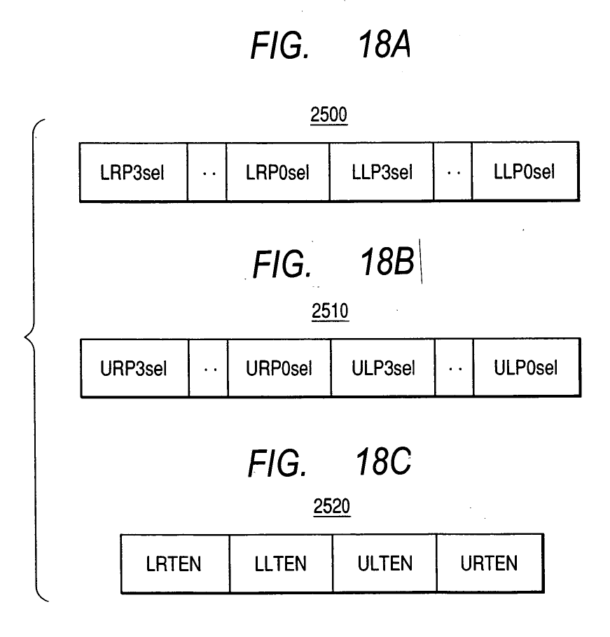

A mechanism for accessing an external device using the IOP 2106 described above will be described with reference to FIG. 17 and FIG. 18.

As shown in FIG. 17, the IOPA 2100 executes data access with the AD/DA 206 via an IO device for connection with outside the LSI or the WCE 1201 which is an external module to the ALU array. The IOPA 2100 is a block of IOPs 2106 for one cluster.

The IOPAs 2100 are provided as a pair for the uppermost cluster and the lowermost cluster. A group of signal lines 1321 indicates a bundle of an input/output signal lines 2112 and 2113 to the IO port cell 2106 shown in FIG. 14 and those for the uppermost cluster and the lowermost cluster in the left side. Similarly, a signal line group 1322 indicates a bundle of those for the uppermost cluster and the lowermost cluster in the left side and input/output signal lines.

The signals line groups 1321 and 1322 are selectively connected by a switch 2403 in the EXIOS 1203 to either signal line 1206 or signal line 207 as a target for access.

Configuration registers 2500 and 2510 in the EXIOS shown in FIG. 18 specify connection of the switch 2403.

The configuration register 2500 specifies a target for connection of inputs and outputs to and from the IOP 2106 for the lowermost cluster, while the configuration register 2510 specifies a target for connection of inputs and outputs for the uppermost cluster. In the configuration register 2500, an LRP3sel selects a target for connection of a right port 3 for the lowermost cluster. The port 3 indicates the IO port 2106 in the cluster, and there are a port 2, a port 1, and a port 0 in the descending order. Similarly, the LLP3sel specifies a target for connection of the left port 3 in the uppermost cluster. Also in the configuration register 2510 like in the configuration register 2500, the URP3sel selects a target for connection of the right port 3 in the uppermost cluster, and the ULP3sel selects a target for connection of the left port 3 in the upper most cluster. The same is true also for other ports.

A terminal of the EXIOS 1203 to the outside of the chip is the LSI external terminal to which the line 207 is connected, and has two ports for input and output as a set. Further the EXIOS 1203 has four ports for input and output as a set each as a terminal to an external module other than the ALUAE to which the wiring 1026 for the WCE is connected.

Bits associated with IOP of each of the configuration registers 2500 and 2510 in the EXIOS 1203 are for selection of an LSI external terminal and for selection of an external module terminal. A bit for selection of the LSI external terminal selects an LSI external terminal 1 or an LSI external terminal 2. A bit for selection of an external module terminal selects any of an ALUAE external module terminal 1, an ALUAE external module terminal 2, an ALUAE external module terminal 3, and an ALUAE external module terminal 4.

4. Example of Setting for Data Load/Store Control

Data load/store can access, in addition to access to the local memory MEM 2103 shown in FIG. 14, a hardware module outside the ALUAE 1202 shown in FIG. 17 or an IO device outside the DR chip via the LS cell 2000 shown in FIG. 14. In this embodiment, as shown in FIG. 17, the WCE 1201 as an external hardware module and the ADC/DAC 206 as an external device outside the DR chip will be described as preferred examples. Further the MEM 2103 preferably includes a multi-port memory having two or more ports so that concurrent access can be made from inside and outside the ALUAE 1202. Descriptions are provided for setting and operations in the set state of the configuration registers 2200 (FIG. 15), 2300 (FIG. 16), and 2500 and 2510 (FIG. 18).

4.1 Access to MEM 2103

At first, a method of accessing the MEM 2103 will be described. Access to the MEM 2103 is largely classified to the LS cell inside address generation mode and the ALUA address supply mode according the method of generating an address. The LS cell inside address generation mode and the ALUA address supply mode will be described in section (1) and section (2) below, respectively.

(1) LS Cell Inside Address Generation Mode

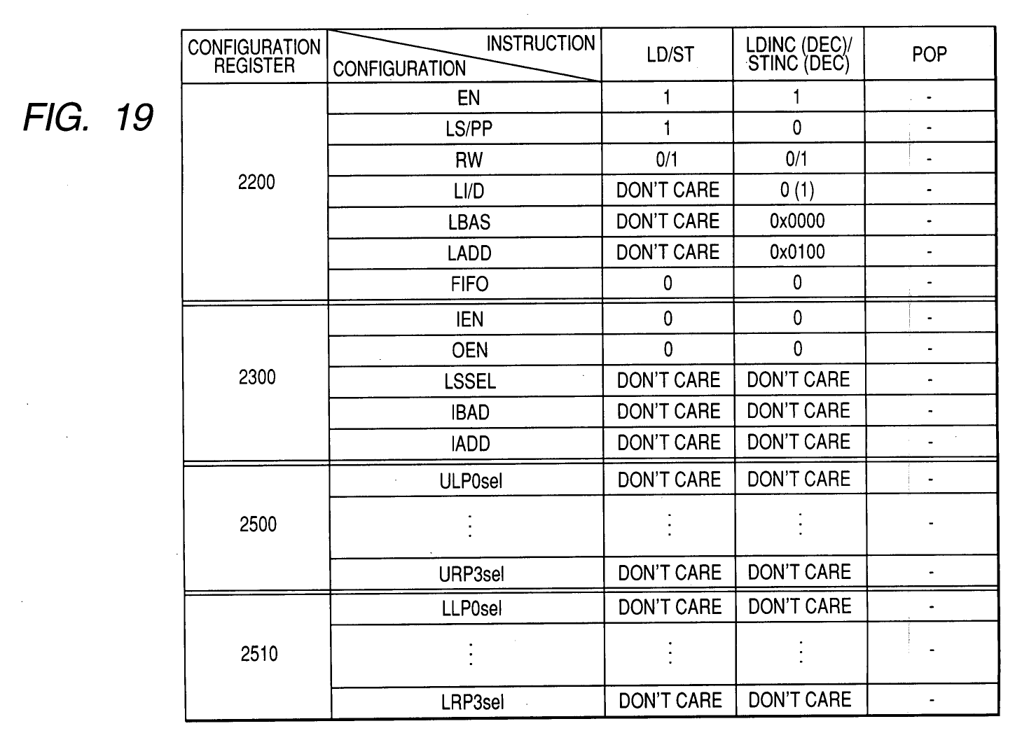

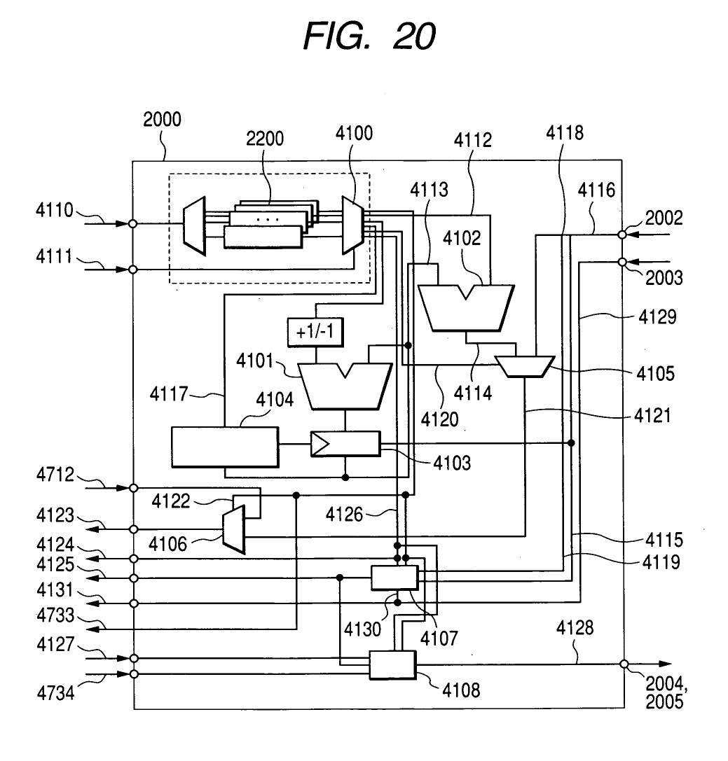

In this mode, memory access is performed according to an address generated in the LS cell 2000. This operation corresponds to an LDINC (DEC)/STINC (DEC) instruction shown in FIG. 19. Descriptions are provided below for setting and examples of operations of the configuration registers 2200, 2300, 2500, and 2510 with reference to the LDINC instruction shown in FIG. 19.

The LDICN instruction generates an address with the base address+displacement, and the displacement is incremented in response to each access to the memory according to the memory read access instruction.

The LDINC instruction is set (LS/PP=0, RW=0, LI/D=0) in a instruction field of the LS cell configuration register 2200, and start addresses for memory spaces used for the base address field and displacement field and a range of the displacement are specified (LBAS=0×0000, LADD=0×0100). Further setting for 0 masking input and output data to and from the EXIOS 1203 is performed (IEN=0, OEN=0) with an input/output mask for the IO port configuration register 2300.

Set conditions for each of the registers above are previously written as values for the configuration registers in a certain state from the CNFGC 1309 shown in FIG. 6. Descriptions are provided for data write in and selection of the LS cell configuration register 2200. In the case of the LS cell, configuration data is written in the LS cell configuration register 2200 through a wiring 4110 shown in FIG. 20. There are a plurality of LS cell configuration registers 2200, and configuration to be executed by the selector 4100 is selected according to a control signal 4111. The control signal 4111 indicates a state corresponding to a cluster number to which the LS cell belongs based on the set conditions 1504 in the C1ST (cluster 1) and C0ST (cluster 0) in the AECTL control register 1500 indicating the configuration state.

In this example, the LS cell configuration register 2200 selected as described above executes the LDINC instruction. At first a logic for address generation will be described below. For the LDICN instruction, an internal address 4114 obtained by adding a signal 4112 to the base address LBAS (0×0000 in this example) in the LS configuration register 2200 and a displacement signal 4113 generated by an adder 4101 with an adder 4102 is used as an address for memory access. The displacement signal 4113 is obtained by accumulating the signal values 1 by 1 with the adder 4101 and the register 4103. The register 4103 is controlled according to a carry-related signal 4115. The carry-related signal 4115 as used herein is a carry input and an enable signal appended to the carry input among signals 4116 inputted through the terminal 2002. The carry signal is 0, a value of the register 4103 is updated, and when the carry signal is 1, the register 4103 is cleared to zero. The carry enable signal is used to determine whether the carry signal is valid or invalid. When the carry signal is effective, the register 4103 is updated or cleared to zero as described above, and when the carry signal is invalid, the current value is maintained. Further the displacement signal 4113 is compared by a comparator 4104 to a signal 4117 indicating the maximum value LADD (0×0100) for displacement, and when the two values are equal to each other, the value of the register 4103 is cleared to zero. With this operation, the range (0×0000 to 0×0100) defined by the LBAS and LADD can be used as an address space for the local memory. Any of the address 4114 generated inside and the address 4188 (signals among the signals 4116 excluding the address enable signal 4119 and carry-related signal 4115) supplied from the ALU cell 2001, and is outputted as a signal 4121. A selection signal 4120 is a signal for LS/PP in the configuration register 2200, and because the LS/PP is 0 (zero) in this example, the address 4114 generated inside is selected. Similarly, when the signal 4114 or a POP instruction described hereinafter is issued, any of the addresses 4712 supplied from the Mctl 2104 is selected by the selector 4106 according to the select signal 4122 and is outputted as a signal 4123. The select signal 4122 is a signal for an FIFO in the configuration register 2200, and because the FIFO is set to 0 in this example, a signal 4121 is selected.

Next descriptions are provided for the logic for generating memory access control signal, i.e., a read/write request signal 4124 and a read/write enable signal 4125. The read/write request signal 4124 corresponds to a RW signal 4126 in the LS cell configuration register 2200, and is transferred to the MEMctl 2104. RW is set to 0 in response to the LDINC instruction, which indicates a read request. The read/write enable signal 4125 is generated by the enable controller 4107 from an address enable signal 4119 and a carry enable signal and is transferred via the wiring 4125 to the MEMctl 2104. Only when these two enable signals are valid, memory access is performed via the MEMctl 2104 in response to the read/write request signal 4124.

Finally, descriptions are provided for an address for the memory access and data read out in response to the control signal. The data read out from the MEM 2103 is inputted as a signal 4127 to the enable controller 4108. The enable controller 4108 delays the read/write enable signal 4125 by a number of memory read cycles in response to a memory read request and combines the signal as an enable signal for the signal 4127 with the signal 4127 to generates a signal 4128. The signal 4128 is transferred from the terminals 2004 and 2005 to the ALU cell 2001.

Since, in this mode, it is not necessary to use the ALUA 1305 for generating an address, the ALUA 1305 can effectively be used for processing.

(2) ALUA Address Supply Mode

In this mode, memory access is performed according to an address inputted from the ALU cell 2001. This operation is associated with the LD/ST instruction shown in FIG. 19. Descriptions are provided below for setting and operations of the configuration registers 2200, 2300, 2500, 2510 with reference to the ST command shown in the figure.

The ST instruction is a instruction for write access to a memory according to an address inputted from the ALU cell 2001, and the LS cell configuration register 2200 is set to (LS/PP=1, RW=1). The setting in the IO port configuration register 2300 not to access the WCE 1201 or the ADC/DAC 206 and the operation for selecting the configuration to be executed from a plurality of LS cell configuration registers 2200 with the selector 4100 are the same as described in section (1) above.

Operations according to the ST instruction in this mode will be described below. Address generation in response to the ST command is the same as that described in section (1) excluding the operations of the selector 4105, and therefore only the differences will be described below. A signal is selected by the selectors 4105 so that the address 4118 supplied from the ALU cell 2001 is outputted as a signal 4123. Because the select signal 4120 (a signal for LS/PP in the configuration register 2200) is set to 1, an address supplied from the ALU cell 2001 is selected by the selector 4105.

Next a memory access control signal will be described below. The read/write request signal 4124 is the same as that described in section (1), and therefore description thereof is omitted herefrom. The read/write signal 4125 is generated by the enable controller 4107 from, in addition to the address enable signal 4119 and the carry enable signal, the data enable signal 4130 indicating whether the data 4131 is valid or invalid among signals 4129 inputted via the terminal 2003, and is transferred via the wiring 4125 to the MEMctl 2104. Only when all of these enable signals are valid, memory access is performed via the MEMctl 2104 based on the read/write request signal 4124. The data 4131 is written in the MEM 2103 according to the address and the control signal described above.

4.2 Access to WCE

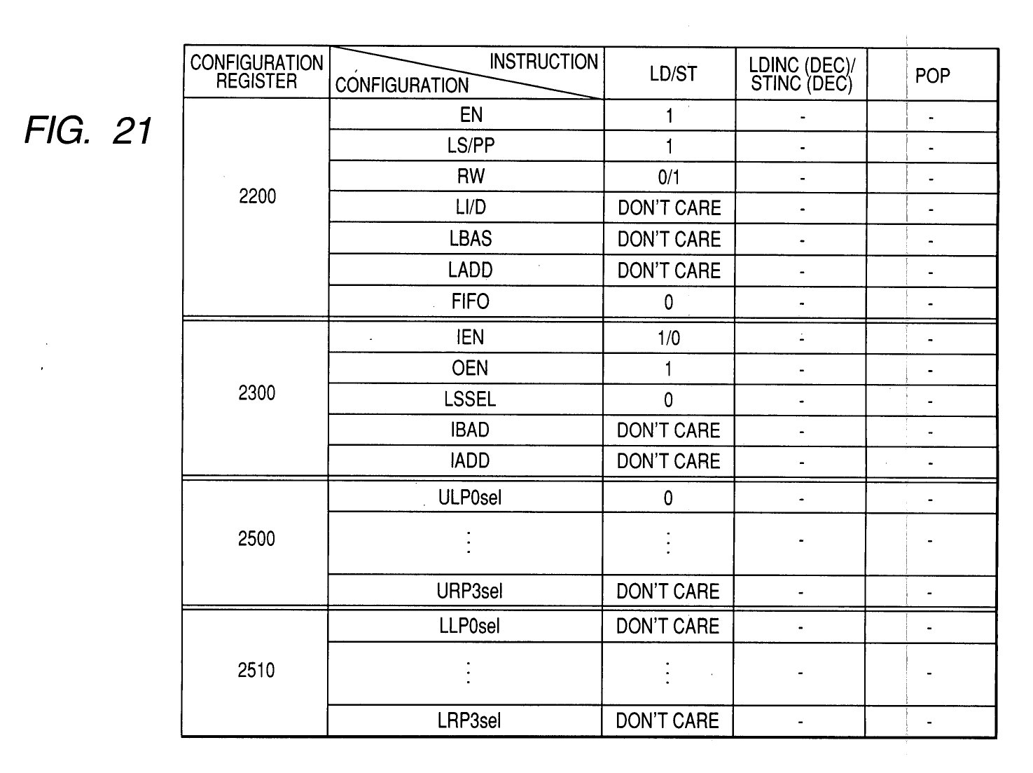

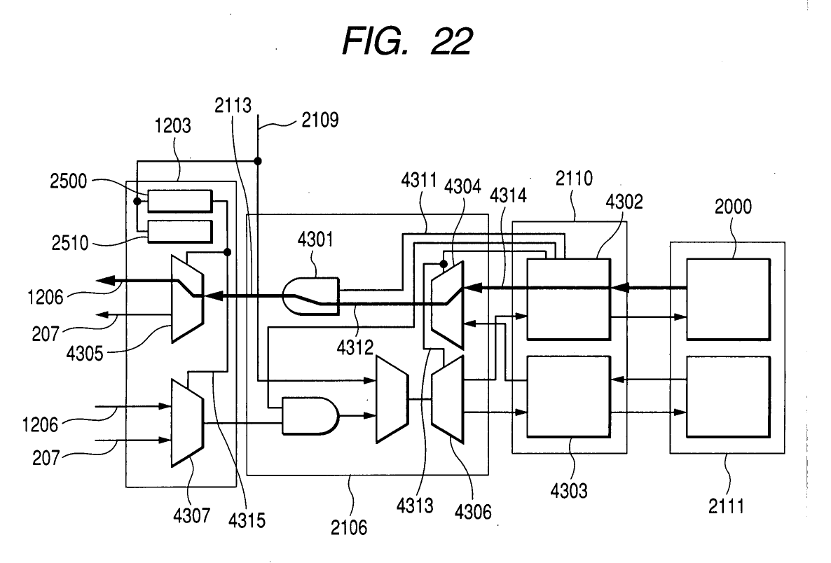

Next a method of access to a WCE 1201 will be described. The WCE 1201 is accessible with an LD/ST instruction. Descriptions are provided below for setting of configuration registers 2200, 2300, 2500, 2510 and an example of operations thereof employing an ST instruction referring to FIG. 21 and FIG. 22. FIG. 21 shows setting of a configuration register and FIG. 22 shows modules associated with an access to WCE 1201. FIG. 22 also shows an LS cell 2000, a set of memory cells 2110 and IOP 2106 each shown in FIG. 14, and EXIOS 1203 shown in FIG. 17. As described above, setting of each register described above is previously written as a value of a configuration register in a certain state from CNFGC 1309 shown in FIG. 6.

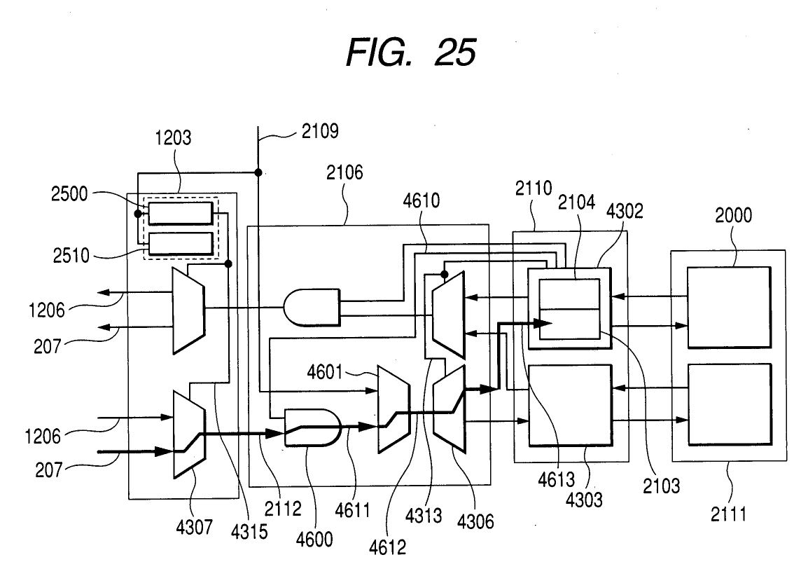

Signals 4311, 4313 shown in FIG. 22 and a signal 4610 shown in FIG. 25 are signals for a configuration selected from a plurality of IO port configuration registers 2300 and to be executed. In the case of the EXIOS, configuration data is written in EXIOS configuration registers 2500, 2510 via wiring 2109 shown in FIG. 22. In case of each of the EXIOS configuration registers 2500, 2510, only one unit exists, unlike the LS cell configuration register 2200 or IO port configuration register 2300.

Setting of the LS cell configuration register 2200 is the same as that of the ST instruction. Setting of the IO port configuration register 2300 and EXIOS configuration registers 2500, 2510 is as shown in FIG. 21. Points of difference of FIG. 21 from FIG. 19 are that OEN of the IO configuration register 2300 is 1, LSSEL of the same is 0, and ULP0sel of the EXIOS configuration register 2500 is 0. OEN indicates the setting of data output enable/disable from the LS cell 2000 to the outside of ALUAE. OEN represents, as shown in FIG. 22, one side input of AND 4301 as a signal 4311. Therefore, as shown in FIG. 21, when OEN is set as 1, an output 4312 from the LS cell side is not 0 masked, but the data is outputted to a signal 2113.

Wiring for an input/output signal between the LS cell side and IOP 2106 has certain flexibility, and setting of LSSEL determines which of a memory cell 4302 on the upper part and a memory cell 4303 on the lower part in FIG. 22 is connected to the outside of ALUAE. LSSEL is used for a selection signal 4113 of selectors 4304, 4306. In this embodiment, by setting LSSEL as 0, a signal 4314 is selected in the selector 4304, so that data is outputted to a signal 4312. In the EXIOS 1203, setting of ULPsel makes selection of the WCE 1201 or ADC/DAC 206 possible as a destination to be connected. ULP0sel is used as a control signal 4315 of selectors 4305, 4307. When the setting is as shown in FIG. 21 (ULP0sel=0), wiring 2113 is selected by the selector 4305 so that the data is outputted to wiring 1206.

With the configuration described above, a write access is performed from the LS cell 2000 via the memory cell 4302 on the upper part to the WCE 1201 as shown in bold line.

4.3 Access to ADC/DAC

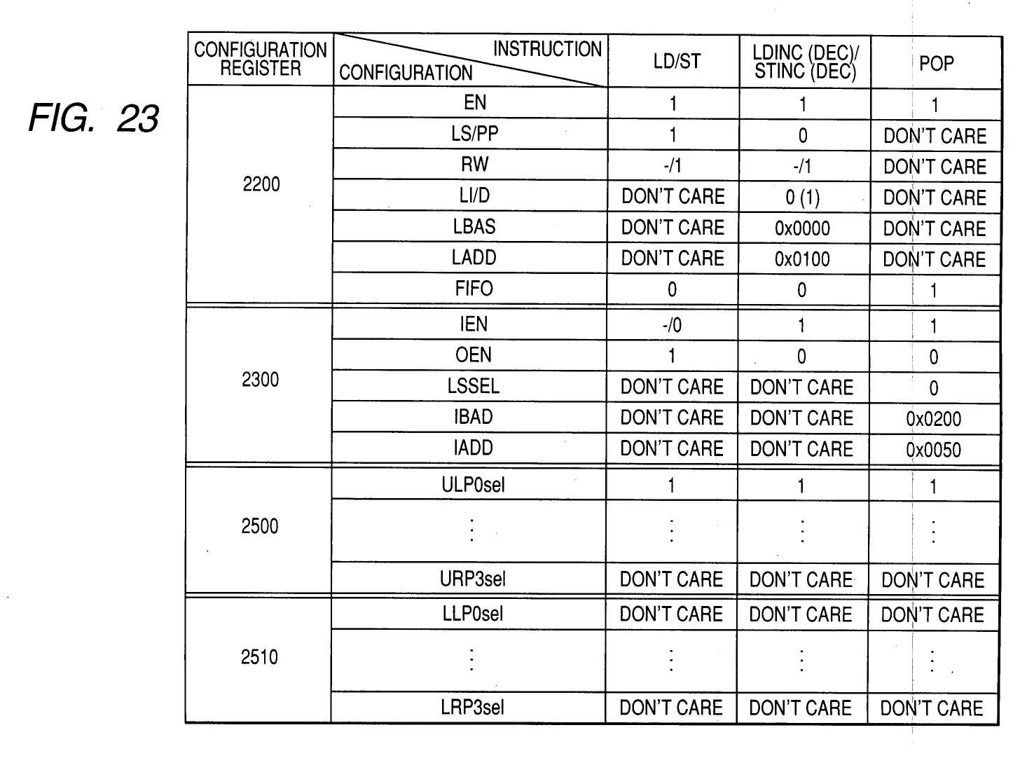

Lastly descriptions are provided for an access to ADC/DAC 206. An access to the ADC/DAC 206 is carried out using another instruction by data output to and data input from the ADC/DAC 206. In relation to each of the data output and data input, descriptions are provided below for setting of configuration registers 2200, 2300, 2500, 2510, and operations thereof according to FIGS. 23 to 26.

(1) Data Output to ADC/DAC

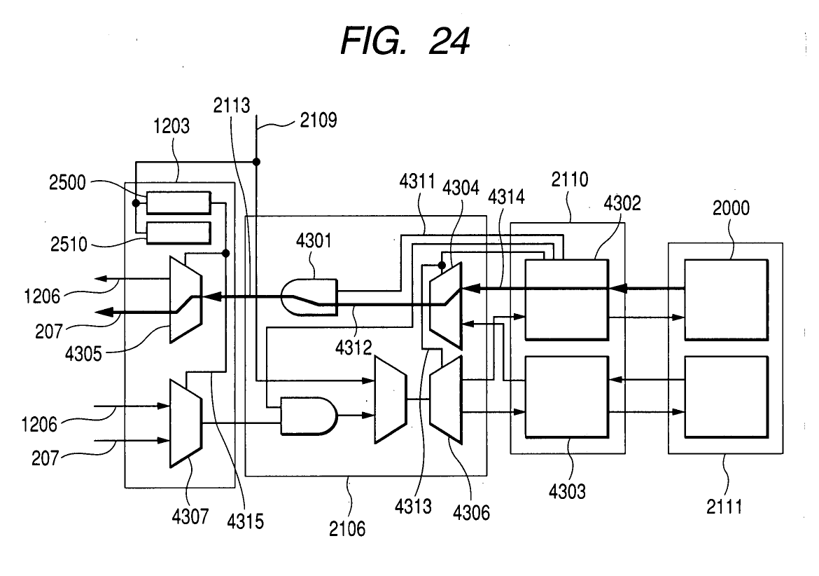

Data output is conducted by an ST instruction and STINC (DEC) instruction shown in FIG. 23. Setting of the LS cell configuration register 2200 is the same as that in the ALUA address supply mode and LS cell address generation mode respectively. Setting of the IO port configuration register 2300 (LSSEL=0, OEN=1) is the same as that in the case of an access to the WCE 1201. Operations in FIG. 24 are also the same as those described in FIG. 22, until the data output is performed from the LS cell 2000 to a signal 2113.

A point of difference from what has been described so far is that the EXIOS configuration registers 2500, 2510 are set as shown in FIG. 23 (ULP0sel=1). In accordance with this setting, a selector 4305 of EXIOS 1203 shown in FIG. 24 selects ADC/DAC 206 as an output destination of a signal 2113 to output the result to wiring 207. With the configuration described above, data can be outputted from the LS cell 2000 via a memory cell 4302 on the upper part to the ADC/DAC 206.

(2) Data Input from ADC/DAC

Data input is conducted by a two-stage operation: (a) to write data inputted from the ADC/DAC 206 in MEM 2103; and (b) to read out the data from the MEM 2103 to the LS cell 2000 under the POP instruction shown in FIG. 23. Descriptions are provided below for each of the operations (a) and (b).

(a) Write from ADC/DAC 206 to MEM 2103

As shown in the POP instruction in FIG. 23, setting is carried out for the IO port configuration register 2300 and the EXIOS configuration registers 2500, 2510. Setting of the ULP0sel to 1 allows to select the wiring 207 with the selector 4307 shown in FIG. 25 to output data to the wiring 2112. IEN indicates data input enable/disable from the outside of ALUAE to the inside thereof, and represents one side input of AND 4600 as a signal 4610. Therefore, by setting IEN to 1 as shown in FIG. 21, an input 2112 from the outside of ALUAE is not 0 masked in the AND 4600, but data thereof is outputted to a signal 4611. The signal 4611 and signal 2109 are inputted to a selector 4601. The selector 4601 preferentially selects the signal 4611 to output the signal as a signal 4612. The selector 4306 determines connection between the memory cell 4302 on the upper part and the memory cell 4303 on the lower part according to setting of LSSEL. In this embodiment (LSSEL=0), the signal 4612 and signal 4613 are connected to transfer data to the memory cell 4302 on the upper part. With the configuration described above, the data can be transferred from the ADC/DAC 206 to the memory cell 4302 on the upper part as shown in bold line. Descriptions are provided below for the details when data is stored in the MEM 2103 in the memory cell 4302.

When data is inputted from the ADC/DAC 206, the MEM 2103 is operated as FIFO, and a memory access is performed with an address generated in Mctl 2104. The address is generated with a base address and displacement. The displacement is incremented one by one with respect to each memory access.

The maximum value of the base address and displacement described above is set in the IO port configuration register 2300 according to the POP instruction shown in FIG. 23 (In this embodiment, IBAS=0×0200 and IADD=0×050, respectively).

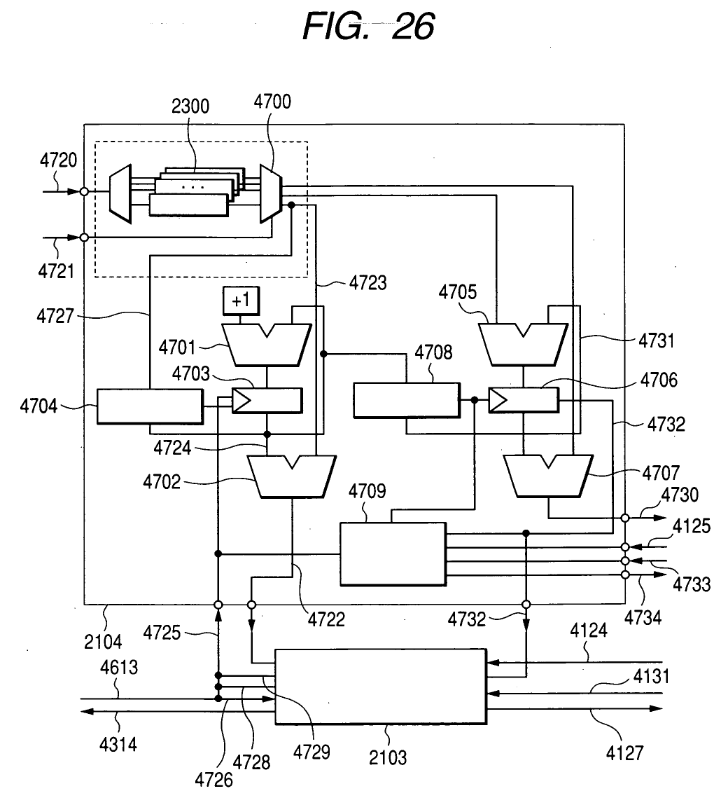

An example of the internal logic of the Mctl 2104, which determines the address of the MEM 2103, is shown in FIG. 26, and will be described below.

Configuration data is written in the IO port configuration register 2300 via the wiring 2109 shown in FIG. 22. Though there exist a plurality of IO port configuration registers 2300, a configuration to be executed by the selector 4300 is selected with a control signal 4310. The control signal 4310 indicates the state associated with a cluster number to which the IO port belongs, based on the setting of C1ST (cluster 1) and C0ST (cluster 0) in an AECTL control register 1500 which show the state of configuration.

Descriptions are now provided for register setting of the IO port configuration register and setting of a register to be executed. Setting of a register is previously written from CNFGC 1309 shown in FIG. 6 via the wiring 4720 for Mctl 2104 shown in FIG. 26. Though there exist a plurality of IO port configuration registers 2300 built in the Mctl 2104, a configuration to be executed by a selector 4700 is selected with a control signal 4721. The control signal 4721 shows the state associated with a cluster number to which the IO port belongs, based on the setting of C1ST (cluster 1) and C0ST (cluster 0) in the AECTL control register 1500 which show the state of configuration.

At first, a logic of generating an address signal 4722 will be described. In the POP instruction, an address is obtained as a signal 4722 by adding with an adder 4702 a signal 4723 of a base address IBAD (0×0200 in this embodiment) in the IO port configuration register 2300 and a signal 4724 of displacement generated with an adder 4701.

The displacement signal 4724 is obtained by accumulatively adding one by one using the adder 4701 and a register 4703. The register 4703 is controlled by a data enable signal 4725. The data enable signal 4725 used herein refers to a signal, among the signals 4613, attached to a data signal 4726 and indicating whether the data is valid or not. When the data enable signal 4725 is 1, the value of the register 4703 is updated, while in turn, when the signal is 0, the current value is maintained. Further, the displacement signal 4724 is compared to a signal 4727 for the maximum value IADD (0×0050) of displacement with a comparator 4704, and then, when both have the same value, the register 4703 is 0 cleared. With this configuration, the range defined by IBAS and IADD (0×0200 to 0×0250) as an address space for a local memory can be utilized.

Next a memory access control signal will be described. Each of a read/write request signal 4728 and a read/write enable signal 4729 is equal to a data enable signal 4725. Therefore, when data 4726 is valid, the read/write request signal 4728 and read/write enable signal 4729 perform a write access to the MEM 2103.

(b) Read from MEM 2103 to LS Cell 2000

To conduct the aforementioned operation, as shown in the column according to the POP instruction in FIG. 23, FIFO of the LS cell configuration register 2200 is set to 1. With this setting, a POP request signal 4733 shown in FIG. 20 is transferred to the Mctl 2104 as a valid signal. The POP request signal 4733 is a signal of FIFO. The selector 4106 shown in the same figure selects an address for POP 4730 generated in the Mctl 2104 and outputs the address to a signal 4123. A description is below made of generation of the POP request signal 4730. A displacement signal 4731 can be obtained by accumulatively adding one by one using an adder 4705 and a register 4706. The register 4706 is controlled by a read/write enable signal 4732. The read/write enable signal 4732 will be described later. When the read/write enable signal 4732 is 1, the value of the register 4706 is updated. On the other hand, when the signal is 0, the current value is maintained. Further the displacement signal 4731 is compared to a regi-displacement signal 4724 with a comparator 4708 and the value of the register 4706 is updated/maintained so that the value does not exceed the compared value. With this configuration, a read address will not outrun a write address, so that the range fixed by IBAS and IADD (0×0200 to 0×0250) can be used.

Next a logic of generating a memory access control signal will be described. The description of the read/write enable signal 4732 is made as explained in 6.3.1, and thus is omitted. The read/write enable signal 4732 is generated by an enable controller 4709 on the basis of the POP request signal 4733 from the LS cell 200, a read/write enable signal 4125, a data enable signal 4725 and the comparative result of a comparator 4708. The read/write enable signal 4732 is valid, only when the POP request signal 4733 from the LS cell is 1, the read/write enable signal 4732 is valid, and the read address does not outrun the write address (namely, FIFO is not empty). Control over the state of FIFO in the enable controller 4709 is not essential in this invention, and is thus omitted herein.

Lastly, a description is made of data read out from an address and a control signal for a memory access described above. The data read out from the MEM 2103 is transferred via a signal 4127 to the LS cell 2000. At the same time, a POP request signal 4733 is correctly received, and a POP acknowledge signal 4734 which indicates that data read out from the MEM 2103 is valid is transferred from the enable controller 4709 to the LS cell 2000. The POP acknowledge signal 4734 is a signal outputted to the LS cell 2000 by delaying a read/write request signal 4732 by the number of memory read cycles with an enable controller 4709. Such a signal is inputted in an enable controller 4108 in the LS cell 2000. The enable controller 4108 integrates the POP acknowledge signal 4734 as an enable signal with the signal 4127 to generate a signal 4128. The signal 4128 is transferred from terminals 2004 and 2005 to the ALU cell 2001.

With the operations (a) and (b) described above, the data inputted from the ADC/DAC 206 can be read out.

Although the present invention will be described above with reference to embodiments thereof, various modifications are possible within the scope not departing from the gist of the present invention.

The description of the reference numerals used in the drawings for the present application is as follows:

106 . . . Software defined radio, 107 . . . Car navigation system, 202 . . . Preprocessing section for a software defined radio, 203 . . . Dynamic reconfigurable (DR) chip, 205 . . . FLASH ROM, 206 . . . ADC/DAC, 700 . . . CPU, 706 . . . Interrupt controller INTC, 708 . . . DR engine, 710 . . . Interrupt request signal, 1201 . . . WC engine, 1202 . . . ALUAE, 1203 . . . EXIOS, 1301 . . . AECTL, 1304 . . . LSAR, 1305 . . . ALU array, 1306 . . . LSAL, 1309 . . . CNFGC, 1311 . . . Subsequent state signal of configuration, 1312, 1313 . . . LMEM, 1700 . . . ALU cell, 2000 . . . LS cell, 2100 . . . Input/output circuit, 2200 . . . Internal local memory, and 2300 . . . Load/store array.

What is claimed is:

1. A semiconductor integrated circuit comprising:
a processing unit having ALU cells arranged in the array state and a function of data transfer of and between ALU cells;
a built-in memory placed around or inside said processing unit; and
a dedicated cell group for performing an address operation for an operand access to said built-in memory:
wherein each of said processing unit and said dedicated cell group has a memory area for dynamically specifying the configuration data thereof.

2. The semiconductor integrated circuit according to claim 1, wherein a plurality of said dedicated cell groups exist in association with a plurality of ALU cells in said processing unit present in the closest position to said built-in memory, and execute an operand access to said built-in memory.

3. The semiconductor integrated circuit according to claim 1, wherein a plurality of said built in memories exist in association with a plurality of said ALU cells in said processing unit, have a single contiguous address space in response to a memory access from the outside of said semiconductor integrated circuit, and have respective address spaces in response to a memory access from said processing unit.

4. The semiconductor integrated circuit according to claim 3, wherein a plurality of said dedicated cell groups exist in association with a plurality of said built-in memories, and execute an operand access uniquely in association with each of the memory accesses.

5. The semiconductor integrated circuit according to claim 1, wherein said dedicated cell groups include said built-in memory; a peripheral device with a dedicated IO interface connected to said semiconductor integrated circuit; and a data access mechanism commonly available to an LSI external device connected with a dedicated IO interface connected to said semiconductor integrated circuit; wherein said dedicated IO interface has a memory area for dynamically specifying a destination for connection thereof.

6. A semiconductor integrated circuit comprising:
a processing unit having ALU cells arranged in the array state;
a built-in memory for storing data processed in said processing unit; and
a dedicated cell group for performing an address operation for an access to said built-in memory;
wherein said processing unit is provided in a first area constituting a quadrangle;
wherein said dedicated cell group is placed along a first side of said quadrangle as well as a second side opposed to said first side; and
wherein said ALU cells have a memory area for determining their own computing function and specifying a destination for connection thereof.

7. The semiconductor integrated circuit according to claim 6, wherein said semiconductor integrated circuit further comprises said processing unit; a circuit module including said built-in memory and said dedicated cell group; a bus connected to said circuit module; and a CPU connected to said bus; wherein said built-in memory is accessible by said dedicated cell group and said CPU.

8. The semiconductor integrated circuit according to claim 6, wherein said dedicated cell group has the same dedicated cells in number as the ALU cells placed along said first side.

9. The semiconductor integrated circuit according to claim 6, wherein said dedicated cell group is connected between said ALU cells and said built-in memory.
